(19) United States
(12) Patent Application Publication
(10) Pub. No.: US 2008/0101541 A1
(43) Pub. Date: May 1, 2008

(54) X-RAY SYSTEM, X-RAY APPARATUS, X-RAY TARGET, AND METHODS FOR MANUFACTURING SAME

(75) Inventors: Gregory Alan Steinlage, Hartland, WI (US); Michael Scott Hebert, Muskego, WI (US); Kirk Alan Rogers, Chagrin Falls, OH (US); Donald Robert Allen, Waukesha, WI (US)

Correspondence Address: RAMIREZ & SMITH, PO BOX 341179, AUSTIN, TX, 78734, US

(73) Assignee: GENERAL ELECTRIC COMPANY, A NEW YORK CORPORATION, Schenectady, NY (US)

(21) Appl. No.: 11/555,532

(22) Filed: Nov. 1, 2006

(51) Int. Cl. H01J 35/08

(52) U.S. Cl. 378/143

(57) ABSTRACT

In some embodiments, an X-ray target is produced by the method of: stacking a primary substrate layer and a focal track layer, the primary substrate layer being formed of primary substrate material, the focal track layer being formed of emitting material; and bonding the emitting material to the primary substrate material by heating a primary compacted interface to an elevated temperature while maintaining the elevated pressure for a time period to form a primary bonded interface of the emitting material and the primary substrate material. In some embodiments, an X-ray target includes a focal track layer of emitting material, a primary substrate layer bonded to the focal track in a primary bonded interface, and a secondary substrate layer bonded to the primary substrate material in a secondary bonded interface by one of diffusion bonding, diffusion brazing and brazing.

### FIELD OF THE INVENTION

The disclosure relates generally to X-ray imaging systems, X-ray apparatus and X-ray targets. The disclosure also relates to methods for manufacturing X-ray systems, X-ray apparatus and X-ray targets.

### BACKGROUND OF THE INVENTION

X-ray imaging systems typically include an X-ray apparatus operable to generate a beam of X-rays, a detection apparatus, and a control system connected to the X-ray apparatus and detection apparatus. The X-ray apparatus produces a beam of X-rays which interact with a subject and are detected by operation of the detection apparatus. One typical example of an X-ray imaging system is a high performance computed tomography (CT) X-ray imaging system, which accommodates a human subject for medical imaging. Medical X-ray imaging systems typically include a gantry which is movable in relation to the human subject.

X-ray apparatus typically include an X-ray tube which is operable to generate a beam of X-rays. A typical X-ray tube includes a housing which forms an evacuated chamber. The housing supports inside the chamber a cathode assembly with a cathode filament. A high voltage electrical circuit is formed between the cathode and an anode assembly supported inside the housing. The anode assembly includes an X-ray target spaced from the cathode filament. The X-ray target includes a generally disk-shaped target cap. The target cap is formed of a high conductivity refractory metal, such as an alloy of molybdenum. An annular focal track on the front surface of the target cap includes a suitable X-ray emitting material, such as a chemical species of high atomic weight, of a type which interacts with high energy electrons to emit X-rays. The X-ray target also includes a heat sink affixed to a rear surface of the target cap. The heat sink receives intense heat conducted away from the focal track and substrate. Typically, the heat sink is formed of an annular block of graphite brazed to the rear surface of the target cap. The target cap is supported for rotation about a longitudinal axis. High speed rotation of the X-ray target is driven by a rotor connected to a drive motor.

For an imaging scan, the electrical circuit energizes the cathode filament to generate high energy electrons which impinge upon the focal track of the X-ray target. Interactions between the electrons and high atomic weight species in the focal track emit high frequency electromagnetic waves, or X-rays. X-rays directed through a window in the chamber housing are focused on a subject for imaging purposes. The electron interactions release intense heat into the focal track and target cap. The X-ray target is rotated by the motor at high speed in order to avoid overheating. Heat is also conducted out of the focal track into the substrate, and then into the heat sink. Heat dissipates from the heat sink through evacuated space in the chamber and into the housing. The housing is cooled by immersion in an external fluid bath.

Conventional X-ray targets presently possess material densities ranging from about 90.0% to about 95.0% of theoretical density. X-ray targets possessing material densities ranging from about 90.0% to about 95.0% of theoretical density are hindered by remaining porosity and porosity variation. X-ray targets can be produced by a “PSF” method by cold pressing (P) a form of substrate material and X-ray emitting material, sintering (S) the cold pressed form, and forging (F) the sintered form to desired shape. X-ray targets produced by the PSF method can possess material densities ranging from about 90.0% to about 95.0% of theoretical density. X-ray targets produced by the PSF method can be hindered by limited density, density variations, remaining porosity, porosity variations, limited mechanical strength properties, variation of mechanical strength properties, limited thermal conductivity, limited thermo-mechanical properties, limited thermal loading capacity, limited mechanical loading capacity. Examples of specific properties limited by the foregoing include: resistance to creep, tensile strength, compressive strength, thermal conductivity, bulk modulus, yield strength, mass per unit diameter, X-ray target diameter, thermal durability per unit of mass, mechanical durability per unit of mass, fatigue resistance, resistance to fatigue crack growth, resistance to crack growth, focal track life, and focal track performance. X-ray apparatus including X-ray targets having the foregoing limitations are hindered by limited capacity to operate at peak power, limited X-ray target rotation speed, limited gantry rotation speed, limited X-ray output at peak power, limited frequency of exposures at peak power, longer cooling periods between exposures, and limited cycle rate.

The specified limitations of X-ray targets produced by the PSF method can worsen as diameter of the X-ray target increases. Targets produced by the PSF method can suffer CTE mismatched bending stress or warpage because of differences between material properties of the focal track and the substrate material supporting the focal track. X-ray targets produced by the PSF method are hindered by the limitation that microstructure of the substrate and focal track materials is not highly controlled and, thus, variations of material properties such as microstructure and variation of microstructure are not optimal and are subject to great variation.

For reasons stated above and for other reasons which will become apparent to those skilled in the art upon reading and understanding the present specification, there is a need in the art for improved X-ray targets, X-ray tubes, X-ray apparatus, and X-ray imaging systems, and for improved methods of manufacturing the same.

### BRIEF DESCRIPTION OF THE INVENTION

The above-mentioned shortcomings, disadvantages and problems are addressed herein, as will be understood by those skilled in the art upon reading and studying the following specification.

In one aspect, systems, apparatus, and methods are provided through which X-ray imaging systems, X-ray apparatus, X-ray tubes, anode assemblies, and X-ray targets include an X-ray target produced by the method of: stacking a primary substrate layer and a focal track layer, the primary substrate layer being formed of primary substrate material defining a primary front surface, the focal track layer being formed of emitting material defining a focal track rear surface, a primary front transition of the primary front surface being in abutting relationship with a focal track rear transition of the focal track rear surface; compacting the emitting material and the primary substrate material together at elevated pressure to bring the primary front transition and the focal track rear transition into intimate abutting relationship, cooperation of the primary front transition and the focal track rear transition defining a primary compacted interface between the primary substrate material and the emitting material; and bonding the emitting material to the primary substrate material in the primary compacted interface by heating the primary compacted interface to an elevated temperature while maintaining the elevated pressure for a time period to form a primary bonded interface of the emitting material and the primary substrate material.

In one aspect, systems, apparatus and methods are provided through which X-ray imaging systems, X-ray apparatus, anode assemblies, and X-ray targets include an X-ray target manufactured by the method of: stacking a focal track layer of emitting material and a primary substrate layer of primary substrate material, the primary substrate layer having a primary front surface, the primary front surface having a primary front transition, the primary substrate material having a predetermined microstructure formed by imparting mechanical work into the primary substrate material sufficient to form the predetermined microstructure; and bonding the emitting material to the primary substrate material in the primary front transition in a primary bonded interface, the emitting material and the substrate material in the primary bonded interface being bonded by one of diffusion bonding, diffusion brazing and brazing.

In one aspect, systems, apparatus, and methods are provided through which X-ray imaging systems, X-ray apparatus, anode assemblies, and X-ray targets include an X-ray target including: a focal track layer of emitting material, the focal track layer having a front surface and a focal track rear transition spaced from the front surface; a primary substrate layer formed of a wrought sheet of primary substrate material, the primary substrate layer having a primary front transition bonded to the focal track rear transition in a primary bonded interface, the primary substrate and the emitting material in the primary bonded interface being bonded by one of diffusion bonding, diffusion brazing and brazing, the primary substrate material having a refined microstructure formed by imparting mechanical work into the primary substrate material sufficient to form the refined microstructure; and a secondary substrate layer of secondary substrate material adjacent the primary substrate layer, the secondary substrate layer having a secondary front transition bonded to a primary rear transition of the primary substrate material in a secondary bonded interface, the secondary substrate material and the primary substrate material in the secondary bonded interface being bonded by one of diffusion bonding, diffusion brazing and brazing.

Apparatus, systems, and methods of varying scope are described herein. In addition to the aspects and advantages described in this summary, further aspects and advantages will become apparent by reference to the following drawings, detailed description and claims.

### BRIEF DESCRIPTION OF THE DRAWINGS

FIG. 1 is a simplified block diagram of an X-ray imaging system 100 according to an embodiment;

FIG. 2 is a partial perspective view of an X-ray apparatus 140 according to an embodiment, with parts broken away, parts in section, and parts omitted;

FIG. 3 is a front elevation view of the X-ray target 250 (shown generally in FIG. 2) according to an embodiment;

FIG. 4 is a cross section of the X-ray target 250 taken generally along line 4-4 in FIG. 3;

FIG. 5 is a partial simplified cross section diagram of the X-ray target 250 shown in FIG. 4;

FIG. 6 is a partial simplified cross section diagram of an X-ray target 540 according to an embodiment;

FIG. 7 is a partial simplified cross section diagram of an X-ray target 560 according to an embodiment;

FIG. 8 is a partial simplified cross section diagram of an X-ray target 580 according to an embodiment;

FIG. 9 is a flowchart illustrating a Method 600 for producing an X-ray target according to an embodiment;

FIG. 10 is a flowchart illustrating a Method 700 for producing an X-ray target according to an embodiment; and

FIG. 11 is a flowchart illustrating a Method 800 for producing an X-ray target according to an embodiment.

### DETAILED DESCRIPTION OF THE INVENTION

In the following detailed description, reference is made to the accompanying drawings which form a part hereof, and in which is shown by way of illustration specific embodiments which may be practiced. These embodiments are described in sufficient detail to enable those skilled in the art to practice the embodiments and disclosure. It is to be understood that other embodiments may be utilized, and that logical, mechanical, electrical, and other changes may be made without departing from the scope of the embodiments and disclosure. In view of the foregoing, the following detailed description is not to be taken as limiting the scope of the embodiments or disclosure.

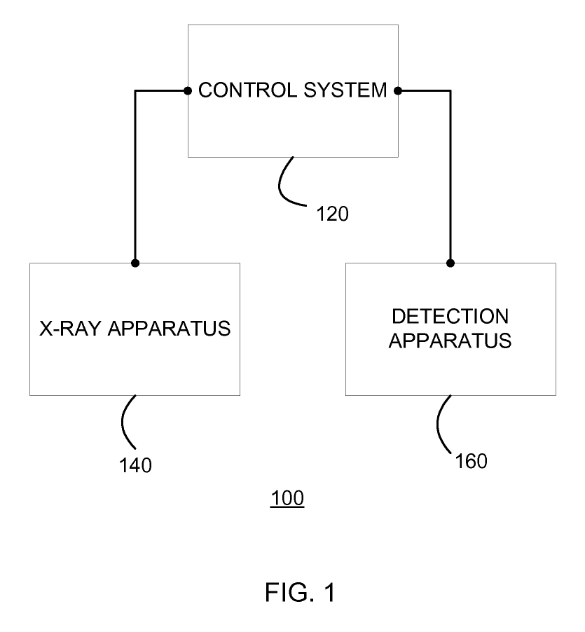

Illustrated in FIG. 1 is a simplified block diagram of an X-ray imaging system 100 according to an embodiment. It is to be understood that an X-ray imaging system 100 according to embodiments of the disclosure can have different arrangements other than the specific representation illustrated in FIG. 1. One example of an X-ray imaging system 100 according to an embodiment is a computed tomography (CT) X-ray imaging system for imaging a human subject. Other specific arrangements of an X-ray imaging system 100 according to embodiments are contemplated. Examples of other embodiments include arrangements for various medical imaging uses and for examination of baggage, containers and other objects.

X-ray imaging system 100 includes a control system 120. X-ray imaging system 100 also includes an X-ray apparatus 140. X-ray apparatus 140 is connected to control system 120 and is operable to generate a beam of X-rays for imaging a subject (not shown). X-ray imaging system 100 also includes a detection apparatus 160. Detection apparatus 160 is connected to control system 120 and is operable to detect X-rays which can interact with the subject (not shown). In some specific arrangements, the X-ray apparatus 140 may include a movable gantry (not shown) connected to the control system 120 and operable for movement along a prescribed path.

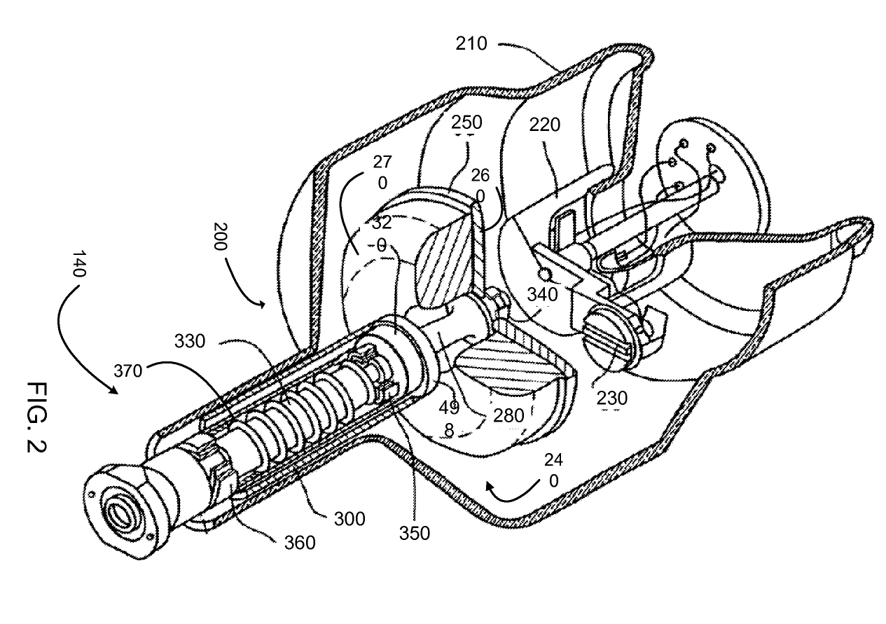

Illustrated in FIG. 2 is a partial perspective view of an X-ray apparatus 140 according to an embodiment, with parts broken away, parts in section, and parts omitted. It is to be understood by those skilled in the art that, for clarity, various elements have been omitted from FIG. 2. X-ray apparatus 140 can have different arrangements other than the specific representation illustrated in FIG. 2. In the specific arrangement illustrated in FIG. 2, the X-ray apparatus 140 includes an X-ray tube 200. It is to be understood that X-ray apparatus 140 according to an embodiment can include, in addition to the illustrated X-ray tube 200, additional elements (not shown in FIG. 2) known by those skilled in the art and which cooperate with X-ray tube 200 to generate X-rays for imaging a subject.

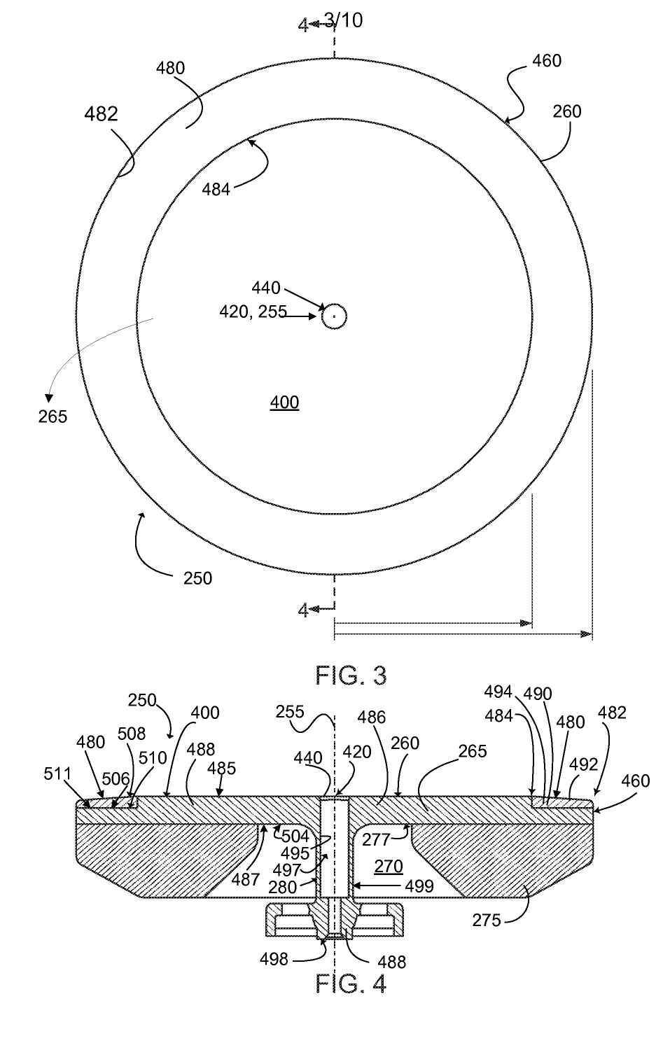

The X-ray tube 200 includes a glass or metal envelope or housing 210. Inside the housing 210 exists a vacuum or evacuated space having a reduced pressure of about 10.sup.-5 to about 10.sup.-9 torr. A cathode assembly 220 including a cathode filament 230 is supported inside the housing 210. The cathode filament 230 is connected to a selectively operable electrical circuit (not shown). The electrical circuit is connected to an anode assembly 240 supported inside the housing 210. The anode assembly 240 includes an X-ray target 250 spaced a fixed distance from the cathode assembly 220 along a longitudinal axis 255 (see FIG. 3). Referring to FIG. 4, the electrical circuit is selectively operable to cause a voltage potential between the cathode filament 230 and anode assembly 240 which generates high energy electrons directed at the X-ray target 250. X-ray target 250 includes a target cap 260 having a disk portion 265 and a rear surface 277, as further described below. A heat sink 270 is affixed to the rear surface 277 of target cap 260 to dissipate heat. X-ray target 250 and target cap 260 also include a stem 280 supporting the disk portion 265, as further described below. The stem 280 is connected to a rotor 300 by a rotor hub 320. Rotor 300 is connected to a motor (not shown) and drives rotation of the target cap 260 about longitudinal axis 255. Target cap 260 is secured to a rotational shaft 330 by a fastener 340. Rotational shaft 340 is operatively supported by a front bearing 350 and rear bearing 360. A preloaded spring 370 is positioned about the rotational shaft 330 between the front bearing 350 and rear bearing 360 for maintaining load on the bearings 350, 360 during thermal expansion and contraction of the anode assembly 240.

FIG. 3 is a front elevation view of the X-ray target 250 (shown generally in FIG. 2) according to an embodiment. The X-ray target 250 includes the generally disk-shaped target cap 260. Viewed along longitudinal axis 255, target cap 260 includes a disk portion 265 having a circular primary front surface 400 facing the cathode assembly 220 and cathode filament 230 (not shown in FIG. 3). The primary front surface 400 has therein a center 420 at longitudinal axis 255. The primary front surface 400 has therein a central hole 440 concentric with the center 420. The primary front surface 400 is symmetrical about center 420 and includes a continuous outer edge 460. Outer edge 460 is spaced outwardly from the center 420 in a radial direction and thus defines an outer radius. The primary front surface 400 includes an annular focal track 480. The focal track 480 has a continuous outer focal track edge 482. In the illustrated arrangement, the outer focal track edge 482 is defined by the outer edge 460. The outer focal track edge 482 is spaced outwardly from the center 420 in the radial direction and thus defines an outer focal track radius. The focal track 480 also has a continuous inner focal track edge 484 intermediate the center 420 and outer focal track edge 482. The inner focal track edge 484 is spaced outwardly from the center 420 in the radial direction and thus defines an inner focal track radius. The focal track 480 defined between the inner focal track edge 484 and outer focal track edge 482 is an annulus on the front surface 400. In the illustrated arrangement, the inner focal track edge 484 is closer to the outer edge 460 than the center 420, such that the annular focal track 480 is adjacent the outer edge 460.

FIG. 4 is a cross section of X-ray target 250 taken generally along line 4-4 in FIG. 3. Referring to FIG. 4, X-ray target 250 includes the target cap 260. Target cap 260 includes a primary substrate layer 485. Primary substrate layer 485 has a generally planar primary front surface 400 defined by primary substrate material 486. Primary substrate layer 485 has a primary rear surface 487 spaced from primary front surface 400 and in general opposition thereto. In the embodiment illustrated in FIG. 4, primary rear surface 487 defines the rear surface 277 of target cap 260. Primary substrate layer 485 and primary substrate material 486 include a generally planar primary front transition 511. Primary front transition 511 is integrally bonded in intimate abutting relationship with the focal track 480 by one of diffusion bonding, diffusion brazing and brazing, as further described below. The primary front transition 511 forms a portion of generally planar primary bonded interface 506. Primary substrate layer 485 also includes a generally planar primary rear surface 504 defined by primary substrate material 486. Primary rear surface 504 is spaced from primary front surface 400 and primary front transition 511 in opposed relation thereto.

In an embodiment, primary substrate layer 485 is a preformed wrought sheet of primary substrate material 486. In an embodiment, primary substrate material 486 is a suitable high conductivity refractory metal. For example, in an embodiment, substrate material 486 is formed of molybdenum, compositions including molybdenum, alloys of molybdenum, compositions including alloys of molybdenum, tungsten, compositions including tungsten, alloys of tungsten, or compositions including alloys of tungsten. In one embodiment, the substrate material 486 is formed of TZM molybdenum alloy containing small amounts of titanium, zirconium and carbon, oxide-dispersion strengthened molybdenum alloy (ODS-Mo), or other carbide-dispersion strengthened alloys.

According to an embodiment, the primary substrate material 486 is dense primary substrate material 488. In an embodiment, the dense primary substrate material 488 is a preformed wrought sheet. According to an embodiment, dense substrate material 488 has a density greater than or equal to about 95.0% of theoretical density. According to one embodiment, dense primary substrate material 488 has a density greater than or equal to about 96.0% of theoretical density. According to one embodiment, dense primary substrate material 488 has a density greater than or equal to about 97.0% of theoretical density. According to one embodiment, dense primary substrate material 488 has a density greater than or equal to about 98.0% of theoretical density. According to one embodiment, dense primary substrate material 488 has a density greater than or equal to about 99.0% of theoretical density. As used herein, “density” means the minimum density within the subject material.

In an embodiment, the primary substrate material 486 has refined microstructure. In an embodiment, the dense primary substrate material 488 has refined microstructure. As used herein, “refined microstructure” means that at least a portion of microstructure of the subject material has refined characteristics formed by imparting mechanical work into the subject material sufficient to form the refined microstructure characteristics. Examples of refined microstructure characteristics include, for example, microstructure diameter and deviations of microstructure diameter from a standard. In an embodiment, the primary substrate material 486 is formed of dense primary substrate material 488 having refined microstructure formed by imparting therein more than about 90.0% of mechanical work. In an embodiment, the dense primary substrate material 488 has refined microstructure formed by imparting therein more than about 95.0% of mechanical work. In an embodiment, the dense primary substrate material 488 has refined microstructure formed by imparting therein more than about 99.0% of mechanical work. In an embodiment, the primary substrate material 486 includes a preformed wrought sheet of dense primary substrate material 488 having refined microstructure as described in the preceding.

Referring to FIG. 4, the focal track 480 is formed of emitting material 490. Emitting material 490 is suitable material known to emit X-rays upon interacting with high energy electrons. According to an embodiment, emitting material 490 is one of a group of chemical species of high atomic number and high melting temperature which are known to emit X-rays. Examples of suitable emitting material 490 include tungsten and alloys of tungsten. In one specific embodiment, the emitting material 490 is a tungsten-rhenium alloy.

The focal track 480 is formed of emitting material 490 in a focal track layer 492 on the primary front surface 400 of the primary substrate material 486 and primary substrate layer 485. The focal track layer 492 includes a generally planar focal track front surface 508 defined by the emitting material 490 and facing the cathode assembly 220. The focal track layer 492 includes a focal track rear transition 510 spaced from the focal track front surface 508 and in general opposition thereto. The focal track rear transition 510 defines a generally planar emitting material portion of the primary bonded interface 506. Focal track layer 492 also extends between the inner focal track edge 484 and outer focal track edge 482 in an annulus on the primary front surface 400.

The focal track layer 492 of emitting material 490 is formed on the primary front transition 511 of primary front surface 400 and primary substrate layer 485 in a suitable manner. In an embodiment, the focal track layer 492 of emitting material 490 is integrally joined to the primary substrate material 486 in the primary front transition 511 of the primary substrate layer 485 by one of diffusion bonding, diffusion brazing and brazing. As used herein, “diffusion bonding” means that the emitting material 490 and primary substrate material 486 are integrally bonded together in intimate relationship in the primary bonded interface 506 in the absence of a brazing material or adhesive agent, as elsewhere described herein. In an embodiment (not shown), the focal track layer 492 is integrally joined to the primary front transition 511 by diffusion brazing. As used herein, “diffusion brazing” means that the primary substrate material 486 and emitting material 490 are bonded by at least one of a layer (not shown in FIG. 4) of liquid brazing material and a layer of solid brazing material, the brazing material having a melting point under process conditions which is lower than the melting point under process conditions of one of the primary substrate material 486 and the emitting material 490, such that the brazing material is diffused away from the primary bonded interface 506 and into the primary substrate material 486 and emitting material 490 by the process conditions. In an embodiment (not shown), the focal track layer 492 is integrally joined to the primary front transition 511 by brazing. As used herein, “brazing” means that the primary substrate material 486 and emitting material 490 are bonded by at least one of a layer (not shown in FIG. 4) of liquid brazing material and a layer of solid brazing material, the brazing material having a melting point under process conditions which is lower than the melting point under process conditions of both the primary substrate material 486 and emitting material 490, such that the brazing material is liquefied by the process conditions and upon cessation of the process conditions returns to a solid condition in the primary bonded interface 506 between the primary substrate material 486 and emitting material 490. In an embodiment (not shown), the focal track layer 492 is integrally joined to the primary front transition 511 by at least one of diffusion bonding, diffusion brazing and brazing.

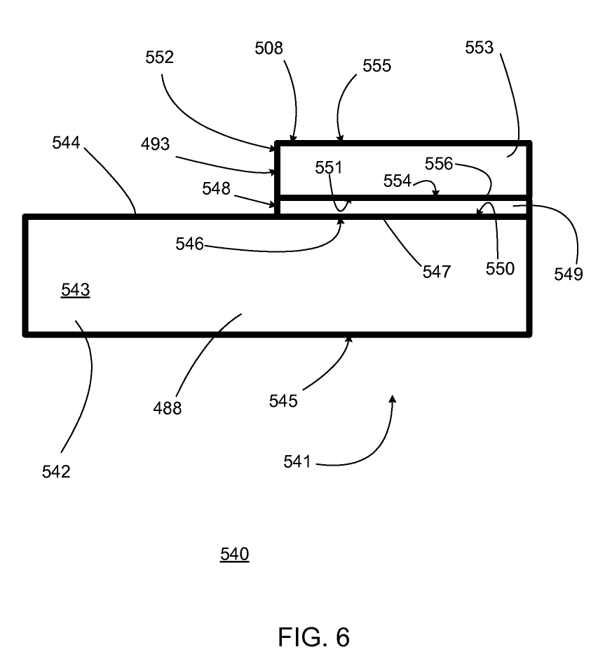

In an embodiment, the focal track layer 492 is a preformed wrought sheet of emitting material 490 joined to the primary front transition 511 by diffusion bonding. In an embodiment (see FIG. 6), the focal track layer 492 is a preformed wrought sheet of emitting material 490 joined to the primary front transition 511 by a primary braze material 520 by diffusion brazing, as elsewhere described herein. In an embodiment, the focal track layer 492 is formed on the primary front transition 511 by depositing the emitting material 490 on the substrate material 486 by powder coating, plasma spraying, electroplating, chemical vapor deposition, or physical vapor deposition.

According to an embodiment, the emitting material 490 is dense emitting material 494. In an embodiment, the dense emitting material 494 is a preformed wrought sheet. According to one embodiment, dense emitting material 494 has a density greater than or equal to about 95.0% of theoretical density. According to one embodiment, dense emitting material 494 has a density greater than or equal to about 96.0% of theoretical density. According to one embodiment, dense emitting material 494 has a density greater than or equal to about 97.0% of theoretical density. According to one embodiment, dense emitting material 494 has a density greater than or equal to about 98.0% of theoretical density. According to one embodiment, dense emitting material 494 has a density greater than or equal to about 99.0% of theoretical density. As used herein and specified above, “density” means the minimum density within the subject material.

In an embodiment, the emitting material 490 has refined microstructure. In an embodiment, the dense emitting material 494 has refined microstructure. As used herein, “refined microstructure” means that at least a portion of microstructure of the subject material has refined characteristics formed by imparting mechanical work into the subject material sufficient to form the refined microstructure characteristics. Examples of refined microstructure characteristics include, for example, microstructure diameter and deviations of microstructure diameter from a standard. In an embodiment, the emitting material 490 is formed of dense emitting material 494 having refined microstructure formed by imparting therein more than about 90.0% of mechanical work. In an embodiment, the dense emitting material 494 has refined microstructure formed by imparting therein more than about 95.0% of mechanical work. In an embodiment, the dense emitting material 494 has refined microstructure formed by imparting therein more than about 99.0% of mechanical work. In an embodiment, the emitting material 490 includes a preformed wrought sheet of dense emitting material 494 having refined microstructure as described in the preceding.

Referring to FIG. 4, central hole 440 in the front surface 400 is defined by intersection of continuous inner wall 495 with primary front surface 400. Inner wall 495 extends along longitudinal axis 255 in parallel spaced relation thereto and thus defines an open cavity 497. Open cavity 497 accommodates the rotational shaft 340 (see FIG. 2). Inner wall 495 reduces diameter in stem 280 and terminates at stem hub 498. Stem 280 has an outer stem wall 499 which returns from the stem hub 498 and intersects rear surface 277. In the embodiment illustrated in FIG. 4, stem 280 is integrally and continuously formed of the same primary substrate material 486 forming target cap 260.

In one embodiment, stem 280 is integrally formed of the same dense substrate material 488 forming primary substrate material 486 and target cap 260. In one embodiment, stem 280 is integrally formed of the same dense substrate material 488 forming primary substrate material 486 and target cap 260 by diffusion bonding. In one embodiment, stem 280 is integrally formed of the same dense substrate material 488 forming primary substrate material 486 and target cap 260 by diffusion brazing. In one embodiment, stem 280 is integrally formed of the same dense substrate material 488 forming primary substrate material 486 and target cap 260 by brazing. In one embodiment, stem 280 is integrally formed of the same dense substrate material 488 forming primary substrate material 486 and target cap 260 by one of diffusion bonding, diffusion brazing and brazing. In one embodiment (not shown), the stem 280 is initially formed of separate material from the substrate material 486, and is then joined with the substrate material 486 by a known method, such as welding. In an embodiment, welding includes friction welding, inertia welding, and brazing. The rear surface 277 of target cap 260 is generally parallel and in spaced opposition to primary front surface 400. Heat sink 270 is integrally affixed to rear surface 277 in thermal communication with primary substrate material 486. The heat sink 270 receives heat conducted away from the focal track 480 and front surface 400 though the primary substrate material 486. In one embodiment, the heat sink 270 is formed of an annular block of graphite 275. In one embodiment, the heat sink 270 is formed of suitable material having sufficiently high heat capacity and thermal emission to rapidly dissipate intense heat and sufficient mechanical strength to endure high speed rotation through repeated heating and cooling cycles. In one embodiment, the heat sink 270 is integrally affixed to the rear surface 277 by brazing. In one embodiment, the heat sink 270 is integrally affixed to the rear surface 277 by diffusion bonding. In one embodiment, the heat sink is integrally affixed to the rear surface 277 by diffusion brazing.

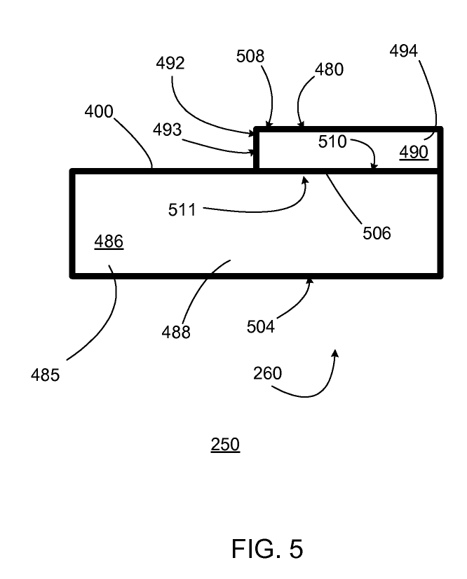

FIG. 5 is a partial simplified cross section diagram of the X-ray target 250 shown in FIG. 4. X-ray target 250 includes the target cap 260. Target cap 260 includes primary substrate layer 485 and focal track layer 492 integrally joined by intimate bonding at primary bonded interface 506. The primary bonded interface 506 includes the primary substrate material 486 in generally planar primary front transition 511 and the emitting material 490 in generally planar focal track rear transition 510. The primary front transition 511 and focal track rear transition 510 thus cooperate to define the generally planar primary bonded interface 506. In the primary bonded interface 506, the primary front transition 511 is integrally bonded in intimate abutting relationship to the focal track rear transition 510 by one of diffusion bonding, diffusion brazing and brazing of the primary substrate material 486 to the emitting material 490 therein. In an embodiment, the primary substrate material 486 in the primary front transition 511 is diffusion bonded to the emitting material 490 in the abutting focal track rear transition 510. The primary substrate material 486 in the primary front transition 511 and the emitting material 490 bonded thereto in the abutting focal track rear transition 510 cooperate to define the primary bonded interface 506. The primary bonded interface 506 thus includes the primary front transition 511 of primary substrate material 486 and the focal track rear transition 510 of emitting material 490 bonded thereto in intimate abutting relationship by diffusion bonding. As used herein, in one embodiment, diffusion bonding means bonding between subject materials in a bonded interface in the absence of a brazing material or adhesive agent. As used herein, in one embodiment, diffusion bonding means bonding in a bonded interface between subject materials by diminution of a contaminant in at least one of the subject materials in the bonded interface. As used herein, in one embodiment, diffusion bonding means bonding in a bonded interface between subject materials by diminution of void spaces in at least one of the subject materials in the bonded interface. As used herein, in one embodiment, diffusion bonding means bonding in a bonded interface between subject materials either by diminution of a contaminant due to migration of the contaminant away from the bonded interface or by diminution of void spaces due to microstructure migration in at least one of the subject materials in the bonded interface. In one embodiment, the primary front transition 511 is bonded in intimate abutting relationship to the focal track rear transition 510 by diffusion brazing of the primary substrate material 486 to the emitting material 490 therein. “Diffusion brazing” was previously described herein. In one embodiment, the primary front transition 511 is bonded in intimate abutting relationship to the focal track rear transition 510 by brazing of the primary substrate material 486 to the emitting material 490 therein. “Brazing” was previously described herein. In an embodiment, the primary front transition 511 is bonded in intimate abutting relationship to the focal track rear transition 510 by one of diffusion bonding, diffusion brazing and brazing.

According to an embodiment, the primary substrate material 486 at the primary front transition 511 has therein primary bonded transition voids (not shown) collectively defining a volume. Volume of the primary bonded transition voids is expressed as a percentage of volume of the primary front transition 511. According to an embodiment, the emitting material 490 at the focal track rear transition 510 has therein emitting bonded transition voids (not shown) collectively defining a volume. Volume of the emitting bonded transition voids (not shown) is expressed as a percentage of volume of the focal track rear transition 510. According to an embodiment, at least one of the volume of the primary bonded transition voids is less than a volume of preceding primary substrate surface voids (not shown) and the volume of the emitting bonded transition voids is less than a volume of preceding emitting material surface voids (not shown). As used herein, “preceding” means surface voids which existed in the respective material before the materials were bonded together by diffusion bonding. According to one embodiment, at least one of the volume of the primary bonded transition voids and the volume of the emitting bonded transition voids is about zero.

According to one embodiment, the primary substrate material 486 at the primary front transition 400 includes a reduced portion of a primary substrate contaminant (not shown). The primary substrate contaminant is diffused away from the primary front transition 511 and primary bonded interface 506. According to an embodiment, the primary substrate contaminant is a reduced portion of a layer of oxide (not shown) of the substrate material 486. In one embodiment, the emitting material 490 at the focal track rear transition 510 includes a reduced portion of an emitting material contaminant (not shown). The emitting material contaminant is diffused away from the focal track rear transition 510 and primary bonded interface 506. According to an embodiment, the emitting material contaminant is a reduced portion of a layer of an oxide (not shown) of the emitting material 490. According to an embodiment, at least one of the primary substrate contaminant is a reduced portion of the primary front transition 511 and the emitting material contaminant is a reduced portion of the focal track rear transition 510. As used herein, “reduced portion” means that the amount of a respective contaminant is less than a preceding amount of contaminant which existed in the respective material before the materials were bonded together by diffusion bonding. According to an embodiment, at least one of the primary substrate contaminant is eliminated from the primary substrate material in the primary front transition and the emitting material contaminant is eliminated from the emitting material in the focal track rear transition.

FIG. 6 is a partial simplified cross section diagram of an X-ray target 540 according to an embodiment. X-ray target 540 includes target cap 541. Target cap 541 includes primary substrate layer 542 formed of primary substrate material 543 defining generally planar primary front surface 544 and opposed primary rear surface 545. Primary substrate material 543 at generally planar primary front transition 546 forms a portion of primary bonded interface 547. Target cap 541 includes braze material layer 548 bonded to primary substrate layer 542 at generally planar primary bonded interface 547. Braze material layer 548 is formed of braze material 549 defining generally planar braze material rear transition 550 and opposed braze material front transition 551 in spaced relation thereto. In an embodiment, braze material rear transition 550 is bonded in intimate abutting relationship to the primary front transition 546 by diffusion brazing therein of braze material 549 to primary substrate material 543 in the primary bonded interface 547. “Diffusion brazing” was previously described herein. In an embodiment, braze material rear transition 550 is bonded in intimate abutting relationship to the primary front transition 546 by brazing therein of braze material 549 to primary substrate material 543 in the primary bonded interface 547. “Brazing” was previously described herein. Braze material front transition 551 is bonded in intimate abutting relationship to focal track layer 552. Focal track layer 552 is formed of emitting material 553 defining generally planar focal track rear transition 554 and opposed focal track front surface 555 in spaced relation thereto. In an embodiment, focal track rear transition 554 is bonded in intimate abutting relationship to the braze material front transition 551 by diffusion brazing therein of emitting material 553 to braze material 549 in generally planar secondary bonded interface 556. “Diffusion brazing” was previously described herein. In an embodiment, braze material front transition 551 is bonded in intimate abutting relationship to the focal track rear transition 554 by brazing therein of braze material 549 to emitting material 553 in the secondary bonded interface 556. “Brazing” was previously described herein.

In an embodiment, the primary substrate material 543 at the primary front transition 546 has therein primary bonded transition voids (not shown) as previously described herein. In an embodiment, braze material 549 the braze material rear transition 550 has therein braze bonded rear transition voids (not shown) having a volume expressed as a percentage of volume of braze material rear transition 550. In an embodiment, braze material 549 at the braze material front transition 551 has therein braze bonded front transition voids (not shown) having a volume expressed as a percentage of volume of braze material front transition 551. In an embodiment, the emitting material 553 at the focal track rear transition 554 has therein emitting bonded transition voids (not shown) having a volume expressed as a percentage of volume of the focal track rear transition 554.

According to an embodiment, the primary substrate material 543 at the primary front transition 546 includes a reduced portion of a primary substrate contaminant (not shown). According to an embodiment, braze material 549 at the braze material rear transition 550 includes a reduced portion of braze material contaminant (not shown). According to an embodiment, at least one of the primary substrate contaminant is a reduced portion of the primary front transition 546 and the braze material contaminant is a reduced portion of braze material rear transition 550. According to an embodiment, at least one of the primary substrate contaminant is a reduced portion of a layer of oxide of the primary substrate material 543 reduced in amount by diffusion bonding of the primary front transition 546 in primary bonded interface 547 and the braze material contaminant is a reduced portion of a layer of oxide of the braze material 549 reduced in amount by diffusion bonding of the braze material rear transition 550 in primary bonded interface 547.

According to an embodiment, the emitting material 553 at the focal track rear transition 554 includes a reduced portion of an emitting contaminant (not shown) as previously described herein. According to an embodiment, braze material 549 at the braze material front transition 551 includes a reduced portion of braze material contaminant (not shown). According to an embodiment, at least one of the emitting material contaminant and braze material contaminant is a reduced portion of the respective focal track rear transition 554 and braze material front transition 551. According to an embodiment, at least one of the emitting material contaminant is a reduced portion of a layer of oxide of the emitting material 553 reduced in amount by diffusion bonding of the focal track rear transition 554 in secondary bonded interface 556 and the braze material contaminant is a reduced portion of a layer of oxide of the braze material 549 reduced in amount by diffusion bonding of the braze material front transition 551 in secondary bonded interface 556.

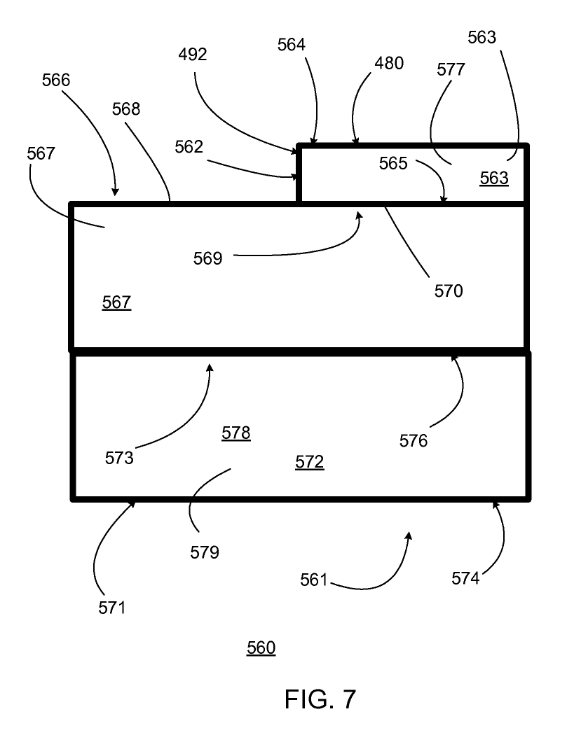

FIG. 7 is a partial simplified cross section diagram of an X-ray target 560 according to an embodiment. X-ray target 560 includes target cap 561. Target cap 561 includes focal track layer 562 formed of emitting material 563 defining generally planar focal track front surface 564 and opposed focal track rear transition 565 in spaced relation thereto. Target cap 561 includes primary substrate layer 566 formed of primary substrate material 567 defining generally planar primary substrate front surface 568. Primary substrate front transition 569 is generally coplanar with primary substrate front surface 568. Focal track rear transition 565 and primary substrate front transition 569 are integrally joined by diffusion bonding of emitting material 563 and primary substrate material 567 at primary bonded interface 570. The focal track rear transition 565 is bonded in intimate abutting relationship to primary substrate front transition 569 by diffusion bonding of the emitting material 563 and primary substrate material 567 in the primary bonded interface 570. Target cap 561 includes secondary substrate layer 571 formed of secondary substrate material 572 defining generally planar secondary substrate front transition 573 and opposed secondary substrate rear surface 574 in spaced relation thereto. Secondary substrate front transition 573 and primary substrate rear transition 569 are joined by diffusion bonding of secondary substrate material 572 and primary substrate material 567 at secondary bonded interface 576. It is to be understood that, in an embodiment, at least one pair of the emitting material 563 and primary substrate material 567 in the primary bonded interface 570 and the secondary substrate material 572 and primary substrate material 567 at secondary bonded interface 576 is integrally joined by one of diffusion bonding, diffusion brazing, and brazing.

According to an embodiment, the primary substrate layer 566 is a preformed wrought sheet of primary substrate material 567 as previously described herein. Suitable primary substrate material 567 was previously described herein.

According to an embodiment, the secondary substrate layer 571 is a preformed wrought sheet of secondary substrate material 572. According to an embodiment, secondary substrate material 572 can be formed of suitable material previously described herein in reference to the primary substrate material 486. According to an embodiment, the secondary substrate material 572 is dense secondary substrate material 578. In an embodiment, the dense secondary substrate material 578 is a preformed, rolled and wrought sheet. According to an embodiment, dense secondary substrate material 578 has a density greater than or equal to about 95.0% of theoretical density. According to one embodiment, dense secondary substrate material 578 has a density greater than or equal to about 96.0% of theoretical density. According to one embodiment, dense secondary substrate material 578 has a density greater than or equal to about 97.0% of theoretical density. According to one embodiment, dense secondary substrate material 578 has a density greater than or equal to about 98.0% of theoretical density. According to one embodiment, dense secondary substrate material 578 has a density greater than or equal to about 99.0% of theoretical density. As used herein, “density” means the minimum density within the subject material.

In an embodiment, the secondary substrate material 572 has refined microstructure. In an embodiment, the dense secondary substrate material 578 has refined microstructure. As used herein, “refined microstructure” means that at least a portion of microstructure of the subject material has refined characteristics formed by imparting mechanical work into the subject material sufficient to form refined microstructure characteristics. Examples of refined microstructure characteristics include, for example, microstructure diameter and deviations of microstructure diameter from a standard. In an embodiment, the secondary substrate material 572 is formed of dense secondary substrate material 578 having refined microstructure formed by imparting therein more than about 90.0% of mechanical work. In an embodiment, the dense secondary substrate material 578 has refined microstructure formed by imparting therein more than about 95.0% of mechanical work. In an embodiment, the dense secondary substrate material 578 has refined microstructure formed by imparting therein more than about 99.0% of mechanical work. In an embodiment, the secondary substrate material 572 includes a preformed wrought sheet of dense secondary substrate material 578 having refined microstructure as described in the preceding.

Referring to FIG. 7, according to an embodiment, at least one of the primary substrate material 567 in the primary substrate rear transition 569 and the secondary substrate material 572 in the secondary substrate front transition 573 of the secondary bonded interface 576 is formed of lower bond strength material 579. In an embodiment, the lower bond strength material 579 reduces the bond strength of the secondary bonded interface 576. In an embodiment, lower bond strength material 579 has bond strength lower than at least one of the primary substrate material 567 and secondary substrate material 572 and is suitable to resist growth of cracking from one of the primary substrate material 567 and the secondary substrate material 572 into the other of the primary substrate material 567 and the secondary substrate material 572. As used herein, “growth of cracking” means cracking within one of the primary substrate material 567 and the secondary substrate material 572 which grows by transferring through the secondary bonded interface 576 into the other of the primary substrate material 567 and the secondary substrate material 572. In an embodiment, the lower bond strength material 579 includes a locally oxidized portion (not shown) of at least one of the primary substrate material 567 in the primary substrate rear transition 569 and the secondary substrate material 572 in the secondary substrate front transition 573 of the secondary bonded interface 576. In an embodiment, the locally oxidized portion of the at least one of the primary substrate material 567 in the primary substrate rear transition 569 and the secondary substrate material 572 in the secondary substrate front transition 573 of the secondary bonded interface 576 forms a reduced strength bond in the secondary bonded interface 573 with at least the other of the primary substrate material 567 in the primary substrate rear transition 569 and the secondary substrate material 572 in the secondary substrate front transition 573 of the secondary bonded interface 576. In an embodiment, the lower bond strength material 579 includes a locally reacted portion (not shown) of at least one of the primary substrate material 567 in the primary substrate rear transition 569 and the secondary substrate material 572 in the secondary substrate front transition 573 of the secondary bonded interface 576. In an embodiment, the lower bond strength material 579 includes a locally deposited weakening material (not shown) in at least one of the primary substrate material 567 in the primary substrate rear transition 569 and the secondary substrate material 572 in the secondary substrate front transition 573 of the secondary bonded interface 576. In an embodiment, the lower bond strength material 579 includes local voids or gaps (not shown) in at least one of the primary substrate material 567 in the primary substrate rear transition 569 and the secondary substrate material 572 in the secondary substrate front transition 573 of the secondary bonded interface 576. In an embodiment, the local voids or gaps (not shown) prevent diffusion bonding, diffusion brazing or braze bonding in at least a portion of the secondary bonded interface 576. In an embodiment, the lower bond strength material 579 has bond strength lower than at least one of the primary substrate material 567 and secondary substrate material 572 and is suitable to resist growth of cracking in the axial direction from one of the primary substrate material 567 and the secondary substrate material 572 into the other of the primary substrate material 567 and the secondary substrate material 572. As used herein, “growth of cracking in the axial direction” means cracking in the direction of the longitudinal axis 255 within one of the primary substrate material 567 and the secondary substrate material 572. In an embodiment, lower bond strength substrate material 579 is formed of suitable material having bond strength lower than at least one of the primary substrate material 567 and secondary substrate material 572 and is suitable to arrest cracking in the radial direction. It is to be understood that, in an embodiment (not shown), suitable lower bond strength material is included in at least one of the emitting material 563 in the focal track rear transition 565 and the primary substrate material 567 in the primary substrate front transition 569 of the primary bonded interface 570 and is suitable to resist growth of cracking from one of the emitting material 563 and primary substrate material 567 into the other of the emitting material 563 and primary substrate material 567 through the primary bonded interface 570.

In an embodiment, at least one of primary substrate layer 566 and secondary substrate layer 571 has predetermined mechanical strength properties, as elsewhere described herein. In an embodiment, at least one of primary substrate layer 566, secondary substrate layer 571 and focal track layer has therein lower bond strength material 579 suitable to resist growth of cracking into the other of primary substrate layer 566, secondary substrate layer 571 and focal track layer. It is to be understood that, in an embodiment, target cap 561 includes multiple of the primary substrate layer 566 or secondary substrate layer 571 having predetermined mechanical strength properties, and at least one of the primary substrate layer 566 and secondary substrate layer 571 has therein lower bond strength material 579 suitable to resist growth of cracking between the respective layers.

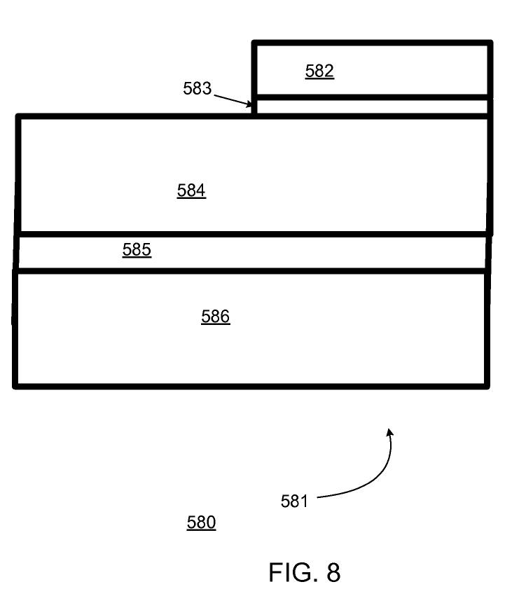

FIG. 8 is a partial simplified cross section diagram of an X-ray target 580 according to an embodiment. X-ray target 580 includes target cap 581. Target cap 581 includes focal track layer 582 bonded in intimate abutting relationship by diffusion bonding to adjacent first braze material layer 583. Target cap 581 includes primary substrate material layer 584 bonded in intimate abutting relationship by diffusion bonding to adjacent first braze material layer 583 and adjacent second braze material layer 585. Target cap 581 includes secondary substrate material layer 586 bonded in intimate abutting relationship by diffusion brazing to adjacent second braze material layer 585.

Embodiments of the disclosure provide an X-ray imaging system 100, X-ray apparatus 140, X-ray tube 200, anode assembly 240, X-ray target 250 and target cap 260 as follows. An embodiment provides an X-ray target including a target cap having increased mechanical strength without decreased thermal conductivity. An embodiment provides an X-ray target including a target cap having increased mechanical strength and increased thermal conductivity. An embodiment provides an X-ray target including a target cap having increased tensile strength. An embodiment provides an X-ray target including a target cap having increased resistance to creep. An embodiment provides an X-ray target including a target cap having reduced porosity. An embodiment provides an X-ray target including a target cap having reduced variations of porosity. An embodiment provides an X-ray target including a target cap having increasingly consistent mechanical properties. An embodiment provides an X-ray target including a target cap having improved thermal and mechanical life per unit of mass. An embodiment provides an X-ray target including a target cap having improved capacity to endure increased thermal and mechanical loading. An embodiment provides an X-ray target including a target cap having reduced mass per unit diameter. An embodiment provides an X-ray target including a target cap having increased capacity to operate at increased peak power, and thus to produce an increased output of X-rays at peak power. An embodiment provides an X-ray target including a target cap having increased capacity to operate with more frequent exposures at peak power and shorter cooling periods between exposures. An embodiment provides an X-ray target including a less massive target cap capable of enduring increased rotation speeds and potentially being of greater diameter. An embodiment provides an X-ray target including a target cap capable of enduring increased gantry rotation speeds. An embodiment provides an X-ray target including a target cap of improved bulk modulus. An embodiment provides an X-ray target including a target cap of increased yield strength. An embodiment provides an X-ray target including a target cap of increased fatigue resistance. An embodiment provides an X-ray target including a target cap of increased resistance to fatigue crack growth. An embodiment provides an X-ray target including a target cap of emitting material having increased resistance to fatigue crack growth in the focal track layer. An embodiment provides an X-ray target including a target cap of substrate material having increased resistance to fatigue crack growth in the substrate material. An embodiment provides an X-ray target including a target cap of emitting material having increased resistance to fatigue crack growth in the axial direction in the focal track layer. An embodiment provides an X-ray target including a target cap of substrate material having increased resistance to fatigue crack growth in the axial direction in the substrate material. An embodiment provides an X-ray target including a target cap of increased resistance to crack growth. An embodiment provides an X-ray target including a target cap of emitting material having increased resistance to crack growth in the focal track layer. An embodiment provides an X-ray target including a target cap of substrate material having increased resistance to crack growth in the substrate material. An embodiment provides an X-ray target including a target cap of emitting material having increased resistance to crack growth in the axial direction in the focal track layer. An embodiment provides an X-ray target including a target cap of substrate material having increased resistance to crack growth in the axial direction in the substrate material. An embodiment provides an X-ray target including a target cap of increased thermal conductivity. An embodiment provides an X-ray target including a target cap having increased focal track life. An embodiment provides an X-ray target including a target cap having increased focal track performance. An embodiment provides an X-ray target including a target cap having decreased radiation output losses over the life of the target cap. An embodiment provides an X-ray target including a target cap having decreased surface roughening over the life of the target cap.

An embodiment of the disclosure provides various improvements, benefits, advantages, features and solutions which will be described in further detail, as follows. X-ray targets in X-ray imaging systems such as computed tomography (CT) systems can be formed with a relatively large diameter target cap and focal track in order to accommodate increased peak power loads and thus provide increased X-ray output and image resolution. The diameter of X-ray targets can be limited by mechanical factors, such as limitations of the mechanical strength, thermal conductivity, and thermo-mechanical durability of the target cap substrate material and emitting material. In X-ray imaging systems such as computed tomography (CT) systems, a gantry rotates at approximately three revolutions per second around a patient and an anode assembly including the X-ray target rotates at approximately 100 to 200 revolutions per second. These rotations create large forces on the X-ray target and target cap that increase exponentially as the diameter and mass of the target cap and X-ray target increase. X-ray targets in X-ray imaging systems can also have a limiting mechanical factor in the thermal conductivity of the target cap substrate material and emitting material. The target cap substrate material and emitting material must be able to conduct heat at specified rates in order to be capable of emitting X-ray energy at a related minimum rate. Limits on the rate of emitting X-ray energy in turn limits the maximum number of imaging scans per unit of time, or usage rate, at which X-ray images can be made by the X-ray imaging system, and thus limits the usefulness of such X-ray imaging systems. During periods of continuous usage of some systems, the maximum usage rate at peak power can also be limited by the length of time required between exposures to adequately dissipate heat from the anode assembly. Operating an X-Ray system repeatedly or continuously at or in excess of the maximum usage rate can cause premature failure of the X-ray tube components, and particularly the X-ray target. Temperatures reached in adjoining components decreases as those components are located increasingly distant from the focal track. Additionally, in order to rapidly dissipate heat from the heat sink, it is effective to rotate the X-ray target at high speed. However, other limitations frequently are prohibitive of continuously rotating the X-ray target in order to dissipate heat. In ordinary use, if the X-ray target and rotor were allowed to continue to rotate between exposures, the bearings would wear rapidly and fail prematurely. Thus, under certain circumstances of ordinary use dictating an excessive time delay between exposures, the X-ray system control system rapidly slows or stops the rotor and X-ray target in a period of seconds. When ready to initiate a scan, the control system returns the rotor and X-ray target to operational rotation speed as quickly as possible. Rapid acceleration and rapid deceleration are utilized because, among other reasons, there are a number of resonant frequencies that must be avoided during acceleration and braking. During such rapid acceleration and rapid braking, mechanical stresses and thermal stresses impact the components of the anode assembly. Embodiments of the disclosure provide X-ray imaging systems, X-ray apparatus, X-ray tubes, anode assemblies, X-ray targets, target caps, and methods for producing the same, having improvements, benefits, advantages, features and solutions which address the foregoing issues.

### Method Embodiments

In the previous section, apparatus embodiments were described. In the present section, and by reference to the accompanying series of flowcharts, are described methods for manufacturing X-ray targets according to embodiments of the disclosure. It is to be understood that embodiments other than those specifically described herein are possible. It is to be understood that methods according to embodiments provide X-ray imaging systems, X-ray apparatus, X-ray tubes, anode assemblies, and X-ray targets having the same features, improvements and benefits described above in reference to the apparatus embodiments. It will be understood by those skilled in the art that X-ray targets are readily manufactured using target caps produced by a method according to the embodiments. It is to be understood that methods according to the embodiments can readily be adapted by one skilled in the art to produce target caps, X-ray targets, anode assemblies, X-ray tubes, X-ray apparatus and X-ray imaging systems.

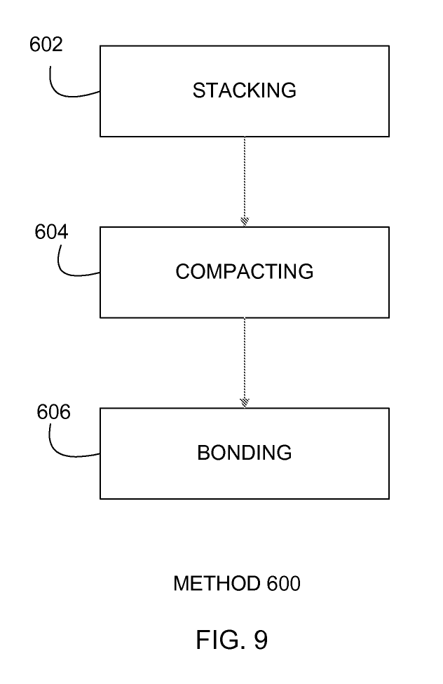

FIG. 9 is a flowchart illustrating a Method 600 to manufacture an X-ray target according to an embodiment. Method 600 includes stacking 602 a primary substrate layer and a focal track layer, the primary substrate layer being formed of primary substrate material defining a primary front surface, the focal track layer being formed of emitting material defining a focal track rear surface, and the primary front surface being in abutting relationship with the focal track rear surface. In an embodiment, the focal track layer is a preformed wrought sheet of emitting material formed of dense emitting material and defining a focal track rear surface, and stacking 602 includes aligning the focal track rear surface of the preformed wrought sheet of emitting material formed of dense emitting material in abutting relationship with the primary front surface of the primary substrate layer. In an embodiment, stacking 602 includes forming the focal track layer of emitting material on the primary front transition of the primary substrate layer in a suitable manner. In an embodiment, stacking 602 includes forming the focal track layer of emitting material on the primary front transition of the primary substrate layer by depositing the emitting material on the primary substrate material by powder coating, plasma spraying, electroplating, chemical vapor deposition, or physical vapor deposition. As used herein, stacking 602 includes aligning a primary substrate layer of primary substrate material and a focal track layer of emitting material in abutting relationship either before or after the primary substrate layer and the focal track layer are forged to desired shape.

Suitable primary substrate material and suitable emitting material were previously described herein. In an embodiment, the primary substrate layer is a preformed rolled and wrought sheet of primary substrate material. According to an embodiment, the primary substrate material is dense primary substrate material as previously described herein. In an embodiment, the dense primary substrate material is a preformed wrought sheet. In an embodiment, the primary substrate material is refined primary substrate material as previously described herein. In an embodiment, the dense primary substrate material is refined dense substrate material as previously described herein. In an embodiment, the primary substrate material is formed of a preformed wrought sheet of refined dense primary substrate material as previously described herein. In an embodiment, the focal track layer is a preformed wrought sheet of emitting material. According to an embodiment, the emitting material is dense emitting material as previously described herein. In an embodiment, the dense emitting material is a preformed wrought sheet. In an embodiment, the emitting material is refined emitting material as previously described herein. In an embodiment, the dense emitting material is refined dense emitting material as previously described herein. In an embodiment, the emitting material is formed of a preformed wrought sheet of refined dense emitting material as previously described herein. In an embodiment, at least one of the primary substrate material is dense substrate material and the emitting material is dense emitting material, as previously described herein. In an embodiment, at least one of the primary substrate material is refined dense substrate material and the emitting material is refined dense emitting material, as previously described herein. In an embodiment, at least one of the primary substrate material is a preformed wrought sheet of refined dense substrate material and the emitting material is a preformed wrought sheet of refined dense emitting material, as previously described herein.

Method 600 includes compacting 604 the emitting material and the primary substrate material together at elevated pressure to bring at least one portion of the primary front surface of the primary substrate layer and at least one portion of the focal track rear surface of the focal track layer into intimate abutting relationship, cooperation of the abutting primary front surface and focal track rear surface defining at least one primary compacted interface between the primary substrate material of the primary substrate layer and the emitting material of the focal track layer. The primary compacted interface includes a primary substrate front transition of the primary substrate material in the primary substrate layer and emitting material in the abutting focal track rear transition of the focal track layer. According to one embodiment, compacting 604 includes cold pressing the emitting material and the primary substrate material. As used herein, “cold pressing” means compacting materials at elevated pressures at about ambient temperature in the presence of atmospheric air. In one embodiment, compacting 604 includes uniaxial compression. In one embodiment, compacting 604 includes isostatic pressing. As used herein, “isostatic pressing” means compacting materials by application of gas pressure. According to one embodiment, compacting 604 includes: compacting the emitting material and primary substrate material together by application of gas pressure between about 35 MPa and about 500 MPa. As used herein, “MPa” means megapascal, wherein 1 megapascal is equal to 10.sup.6 newtons per square meter. Examples of suitable gases are inert gases and reducing gases.

In an embodiment, the primary substrate material forming the primary front transition of the primary compacted interface has therein primary compacted surface voids. Volume of the primary compacted surface voids is expressed as a percentage of volume of the primary front transition. In an embodiment, the emitting material forming the focal track rear transition of the primary compacted interface has therein emitting material surface voids. Volume of the emitting material surface voids is expressed as a percentage of volume of the focal track rear transition.

In an embodiment, the primary substrate material in the primary front transition of the primary compacted interface includes a primary substrate contaminant. In an embodiment, the emitting material in the primary emitting rear transition of the primary compacted interface includes an emitting material contaminant. In an embodiment, at least one of the primary substrate material in the primary front transition of the primary compacted interface includes a primary substrate contaminant and the emitting material in the primary emitting rear transition of the primary compacted interface includes an emitting material contaminant. In an embodiment, the primary substrate contaminant in the primary compacted interface is a layer of oxide of the primary substrate material. In an embodiment, the emitting material contaminant in the primary compacted interface is a layer of oxide of the emitting material. In an embodiment, at least one of the primary substrate material contaminant is a layer of oxide of the primary substrate material in the primary front transition of the primary compacted interface and the emitting material contaminant is a layer of oxide of the emitting material in the focal track rear transition of the primary compacted interface.

Method 600 includes bonding 606 the emitting material to the primary substrate material at the primary compacted interface by heating the primary compacted interface to an elevated temperature while maintaining elevated pressure for a time period to form a primary bonded interface of the emitting material and the primary substrate material. The primary bonded interface includes the primary substrate material in the primary substrate front transition of the primary substrate layer and the emitting material in the focal track rear transition of the focal track layer, the primary substrate material and emitting material being bonded together therein in intimate abutting relationship by diffusion bonding. In one embodiment, bonding 606 includes hot isostatic pressing. As used herein, “hot isostatic pressing” means compacting the emitting material and the primary substrate material together in the primary compacted interface by application of gas pressure, at homologous temperature, for a time period to form diffusion bonding in the primary bonded interface between the emitting material in the focal track rear transition of the focal track layer and the primary substrate material in the primary substrate front transition of the primary substrate layer. As used herein, “homologous temperature” means the ratio of the absolute temperature of a material or component material to the absolute melting temperature of the same material or component material. In one embodiment, bonding 606 includes in the primary bonded interface the primary substrate material and emitting material being bonded together in intimate abutting relationship by one of diffusion bonding, diffusion brazing and brazing. Diffusion bonding, diffusion brazing, and brazing were previously described herein.

According to one embodiment, bonding 606 includes: compacting the emitting material and substrate material by application of gas pressure between about 35 MPa and about 500 MPa, at a homologous temperature between about 0.3 of the lowest melting point component and about 0.8 of the highest melting point component, for a time period. In one embodiment, the time period ranges from at least about 1 minute to at least about 100 hours. In one embodiment, the time period ranges from at least about 1 minute to about 100 hours. In one embodiment, the time period ranges from at least about 30 minutes to about 100 hours. In one embodiment, the time period ranges from at least about 4 hours to about 100 hours. It is to be understood that the ranges of pressure, temperature and time period can vary in embodiments. Examples of suitable gases are inert gases and reducing gases.

Method 600 includes forging 608 the bonded layers of primary substrate material and emitting material to desired shape of the target cap. In one embodiment (not shown), forging 608 includes forging the layers of primary substrate material and emitting material to desired shape of the target cap before the layers of primary substrate material and emitting material are bonded together. Method 600 includes machining 610 the at least one of the primary substrate layer of primary substrate material and the focal track layer of emitting material to impart work into the respective primary substrate material and emitting material. According to an embodiment, work is imparted into at least one of the primary substrate material and the emitting material. According to an embodiment, at least about 90.0% of work is imparted into at least one of the primary substrate material and the emitting material. According to an embodiment, at least about 95.0% of work is imparted into at least one of the primary substrate material and the emitting material. According to an embodiment, at least about 99.0% of work is imparted into at least one of the primary substrate material and the emitting material.

In an embodiment, the primary substrate material forming the primary front transition of the primary bonded interface has therein primary bonded interface voids. In an embodiment, volume of the primary bonded interface voids expressed as a percentage of volume of the primary front transition is less than the volume percentage of the primary compacted surface voids. In an embodiment, volume of the primary bonded interface voids expressed as a percentage of volume of the primary front transition is about zero. In an embodiment, the emitting material forming the focal track rear transition of the primary bonded interface has therein emitting material bonded interface voids. In an embodiment, volume of the emitting material bonded interface voids expressed as a percentage of volume of the focal track rear transition is less than the volume percentage of the emitting material compacted surface voids. In an embodiment, volume of the emitting material bonded interface voids expressed as a percentage of volume of the focal track rear transition is about zero. In an embodiment, at least one of the volume of the primary bonded interface voids expressed as a percentage of volume of the primary front transition is less than the volume percentage of the primary compacted surface voids and the volume of the emitting material bonded interface voids expressed as a percentage of volume of the focal track rear transition is less than the volume percentage of the emitting material compacted surface voids.

In an embodiment, the primary substrate material in the primary front transition of the primary bonded interface includes a primary substrate contaminant which is a reduced amount and less than the primary substrate contaminant included in the primary substrate material in the primary front transition of the primary compacted interface. In an embodiment the primary substrate contaminant included in the primary substrate material in the primary front transition of the primary compacted interface is eliminated by diffusion bonding and thus is absent from the primary substrate material in the primary front transition of the primary bonded interface. In an embodiment, the emitting material in the focal track rear transition of the primary bonded interface includes an emitting material contaminant which is a reduced amount and less than the emitting material contaminant included in the emitting material in the focal track rear transition of the primary compacted interface. In an embodiment, the emitting material contaminant included in the emitting material in the focal track rear transition of the primary compacted interface is eliminated by diffusion bonding and thus is absent from the emitting material in the focal track rear transition of the primary bonded interface. In an embodiment, at least one of the primary substrate material in the primary front transition of the primary bonded interface includes a primary substrate contaminant which is a reduced amount less than the primary substrate contaminant included in the primary substrate material in the primary front transition of the primary compacted interface and the emitting material in the focal track rear transition of the primary bonded interface includes an emitting material contaminant which is a reduced amount less than the emitting material contaminant included in the emitting material in the focal track rear transition of the primary compacted interface. In an embodiment, the primary substrate contaminant in the primary bonded interface is a residual amount of oxide of the primary substrate material. In an embodiment, the emitting material contaminant in the primary bonded interface is a residual amount of oxide of the emitting material. In an embodiment, at least one of the primary substrate material contaminant is a residual amount of oxide of the primary substrate material in the primary front transition of the primary bonded interface and the emitting material contaminant is a residual amount of oxide of the emitting material in the focal track rear transition of the primary bonded interface. As used herein, “residual amount” means a reduced amount in the primary bonded interface which is less than the respective primary substrate contaminant or emitting material contaminant in the primary compacted interface.

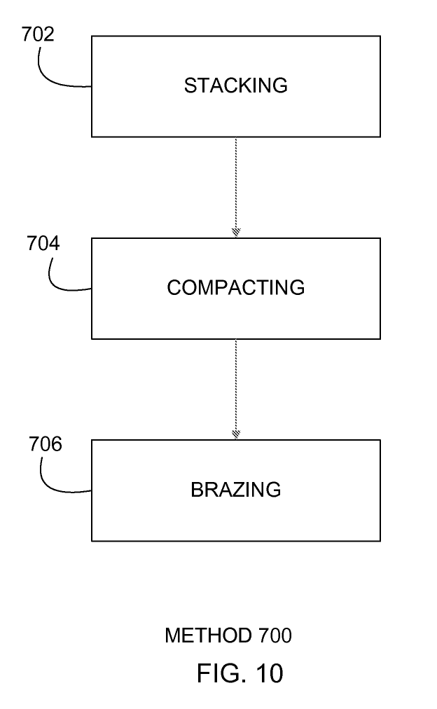

FIG. 10 is a flowchart illustrating a method 700 to manufacture an X-ray target according to an embodiment. Method 700 includes stacking 702 a focal track layer formed of emitting material, the focal track layer having a front surface and an opposed focal track rear surface in spaced relation thereto, a braze material layer adjacent the focal track layer and formed of braze material, the braze material layer having a braze material front surface abutting a portion of the focal track rear surface and having a braze material rear surface in spaced relation to the braze material front surface, and a primary substrate layer adjacent the braze material layer and formed of primary substrate material, the primary substrate layer having a primary front surface abutting a portion of the braze material rear surface and having an opposed primary rear surface in spaced relation to the primary front surface. Embodiments of method 700 include arrangements of stacking 702 as previously described above with reference to stacking 602 in method 600.

Suitable primary substrate material and emitting material were previously described herein. Suitable braze material is an alloy having a melting point lower than the lowest melting point component of the adjacent emitting material and adjacent primary substrate material. In an embodiment, the braze material layer is a preformed wrought sheet. In an embodiment, the braze material is a coating formed on at least one of the emitting material in the focal track rear transition and the primary substrate material in the primary front transition of the primary substrate layer.

Method 700 includes compacting 704 the stacked focal track layer, braze material layer and primary substrate layer together at elevated pressure to bring into intimate abutting relationship a focal track rear transition of the focal track layer and a braze material front transition of the adjacent braze material layer, cooperation of the focal track rear transition and the braze material front transition defining a secondary compacted interface between the emitting material and braze material therein, and to bring into intimate abutting relationship a primary front transition of the primary substrate layer and a braze material rear transition of the braze material layer, cooperation of the primary front transition and the braze material rear transition defining a primary compacted interface between the primary substrate material and braze material therein. According to one embodiment, compacting 704 includes cold pressing adjacent pairs of the stacked emitting material, brazing material and primary substrate material. As used herein, “cold pressing” means compacting materials at elevated pressures at about ambient temperature in the presence of atmospheric air. In one embodiment, compacting 704 includes uniaxial compression. In one embodiment, compacting 704 includes isostatic pressing adjacent pairs of the stacked emitting material, brazing material and primary substrate material. As used herein, “isostatic pressing” means compacting adjacent materials by application of gas pressure. According to one embodiment, compacting 704 includes: compacting the emitting material and adjacent braze material together and the braze material and adjacent primary substrate material together by application of gas pressure between about 35 MPa and about 500 MPa. Examples of suitable gases are inert gases and reducing gases.

Method 700 includes brazing 706 the emitting material in the focal track rear transition to the abutting braze material in the braze material front transition of the secondary compacted interface and the braze material in the braze material rear transition to the abutting primary substrate material in the primary front transition of the primary compacted interface by heating the secondary compacted interface and the primary compacted interface to an elevated temperature while maintaining elevated pressure for a time period to form a secondary bonded interface between the emitting material in the focal track rear transition and the braze material in the braze material front transition and to form a primary bonded interface between the braze material in the braze material rear transition and the primary substrate material in the primary front transition. The secondary bonded interface includes the emitting material in the focal track rear transition of the focal track layer and the braze material in the braze material front transition of the braze material layer, the emitting material and the braze material being bonded together therein in intimate abutting relationship by diffusion bonding. The primary bonded interface includes the primary substrate material in the primary substrate front transition of the primary substrate layer and the braze material in the braze material rear transition of the braze material layer, the primary substrate material and braze material being bonded together therein in intimate abutting relationship by diffusion bonding. In one embodiment, brazing 706 includes hot isostatic pressing. As used herein, “hot isostatic pressing” means compacting together the respective abutting primary substrate material and braze material in the primary compacted interface and the emitting material and braze material in the secondary compacted interface by application of gas pressure, at temperature, for a time period to bond by diffusion bonding the respective abutting primary substrate material and braze material in a respective primary bonded interface replacing the primary compacted interface and to bond by diffusion bonding the respective abutting emitting material and braze material in a respective secondary bonded interface replacing the secondary compacted interface. In one embodiment, brazing 706 includes one of diffusion bonding, diffusion brazing, and brazing. Diffusion bonding, diffusion brazing, and brazing were previously described herein.

According to one embodiment, brazing 706 includes: compacting the emitting material and braze material and the primary substrate material and braze material by application of gas pressure between about 35 MPa and about 500 MPa, at a homologous temperature between about 0.3 of the lowest melting point component and about 0.8 of the highest melting point component, for a time period. In one embodiment, the time period ranges from at least about 1 minute to at least about 100 hours. In one embodiment, the time period ranges from at least about 1 minute to about 100 hours. In one embodiment, the time period ranges from at least about 30 minutes to about 100 hours. In one embodiment, the time period ranges from at least about 4 hours to about 100 hours. It is to be understood that the ranges of pressure, temperature and time period can vary in embodiments. Examples of suitable gases are inert gases and reducing gases.

Method 700 includes forging 708 the bonded layers of primary substrate material, braze material, and emitting material to desired dimensions of the target cap. In one embodiment, forging 708 includes forging the layers of primary substrate material, braze material and emitting material to desired dimensions of the target cap before the layers are bonded together. Method 700 includes machining 710 the bonded layers of primary substrate material, braze material, and emitting material to impart work into the primary substrate material and the emitting material. According to an embodiment, work is imparted into at least one of the primary substrate material and the emitting material. According to an embodiment, at least about 99.0% of work is imparted into the primary substrate material and the emitting material. According to an embodiment, at least about 99.0% of work is imparted into at least one of the primary substrate material and the emitting material.

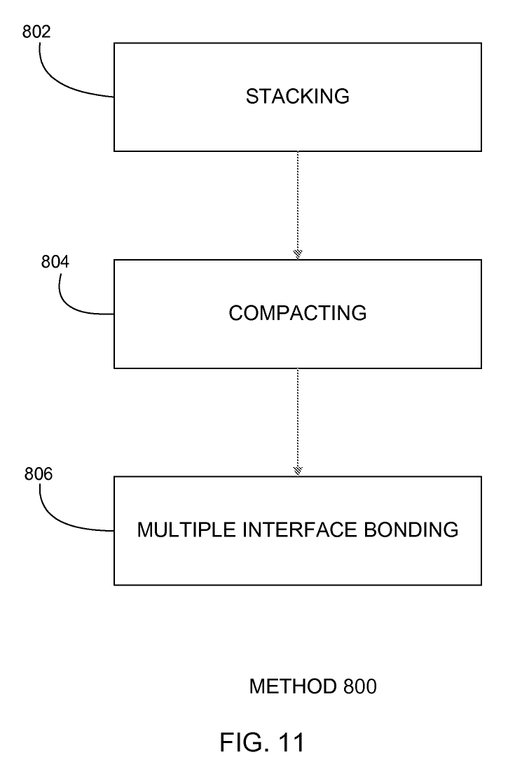

FIG. 11 is a flowchart illustrating a Method 800 to manufacture an X-ray target according to an embodiment. Method 800 includes stacking 802 a focal track layer formed of emitting material, the focal track layer having a front surface and an opposed focal track rear surface in spaced relation thereto, a primary substrate layer adjacent the focal track layer and formed of primary substrate material, the primary substrate layer having a primary front surface abutting a portion of the focal track rear surface and having a primary rear surface in spaced relation to the primary front surface, and a secondary substrate layer adjacent the primary substrate layer and formed of secondary substrate material, the secondary substrate layer having a secondary front surface abutting a portion of the primary rear surface and having an opposed secondary rear surface in spaced relation to the secondary front surface. Suitable primary substrate material, secondary substrate material and emitting material were previously described herein.

Method 800 includes compacting 804 the stacked focal track layer and adjacent primary substrate layer and the primary substrate layer and adjacent secondary substrate layer together at elevated pressure to bring into intimate abutting relationship a focal track rear transition of the focal track layer and a primary front transition of the adjacent primary substrate layer, cooperation of the focal track rear transition and the primary front transition defining a primary compacted interface between the emitting material and primary substrate material therein, and to bring into intimate abutting relationship a primary rear transition of the primary substrate layer and a secondary front transition of the secondary substrate layer, cooperation of the primary rear transition and the secondary front transition defining a secondary compacted interface between the primary substrate material and secondary substrate material therein. According to one embodiment, compacting 804 includes cold pressing adjacent pairs of the stacked emitting material, primary substrate material and secondary substrate material. As used herein, “cold pressing” means uniaxially compacting materials at elevated pressures at about ambient temperature in the presence of atmospheric air. In one embodiment, compacting 804 includes isostatic pressing adjacent pairs of the stacked emitting material, primary substrate material, and secondary substrate material. As used herein, “isostatic pressing” means compacting adjacent materials by application of gas pressure. According to one embodiment, compacting 804 includes: compacting the emitting material and adjacent primary substrate material together and the primary substrate material and adjacent secondary substrate material together by application of gas pressure between about 35 MPa and about 500 MPa. Examples of suitable gases are inert gases and reducing gases.

Method 800 includes multiple interface bonding 806 the emitting material in the focal track rear transition to the abutting primary substrate material in the primary front transition of the primary compacted interface and the primary substrate material in the primary rear transition to the abutting secondary substrate material in the secondary front transition of the secondary compacted interface by heating the primary compacted interface and the secondary compacted interface to an elevated temperature while maintaining elevated pressure for a time period to form a primary bonded interface between the emitting material in the focal track rear transition and the primary substrate material in the primary front transition and to form a secondary bonded interface between the primary substrate material in the primary rear transition and the secondary substrate material in the secondary front transition. The primary bonded interface thus includes the emitting material in the focal track rear transition of the focal track layer and the primary substrate material in the primary front transition of the primary substrate layer, the emitting material and the primary substrate material being bonded together therein in intimate abutting relationship by diffusion bonding. The secondary bonded interface thus includes the primary substrate material in the primary substrate rear transition of the primary substrate layer and the secondary substrate material in the secondary front transition of the secondary substrate layer, the primary substrate material and secondary substrate material being bonded together therein in intimate abutting relationship by diffusion bonding. In one embodiment, multiple interface bonding 806 includes hot isostatic pressing. As used herein, “hot isostatic pressing” means compacting together the respective abutting emitting material and primary substrate material in the primary compacted interface and the primary substrate material and secondary substrate material in the secondary compacted interface by application of gas pressure, at homologous temperature, for a time period to bond by diffusion bonding the respective abutting emitting material and primary substrate material in a respective primary bonded interface replacing the primary compacted interface and to bond by diffusion bonding the respective abutting primary substrate material and secondary substrate material in a respective secondary bonded interface replacing the secondary compacted interface. In one embodiment, multiple interface bonding 806 includes in at least one of the primary bonded interface and the secondary bonded interface respective bonding which includes one of diffusion bonding, diffusion brazing, and brazing.

According to one embodiment, multiple interface bonding 806 includes: compacting the emitting material and primary substrate material and the primary substrate material and secondary substrate material by application of gas pressure between about 35 MPa and about 500 MPa, at a homologous temperature between about 0.3 of the lowest melting point component and about 0.8 of the highest melting point component, for a time period. In one embodiment, the time period ranges from at least about 1 minute to at least about 100 hours. In one embodiment, the time period ranges from at least about 1 minute to about 100 hours. In one embodiment, the time period ranges from at least about 30 minutes to about 100 hours. In one embodiment, the time period ranges from at least about 4 hours to about 100 hours. It is to be understood that the ranges of pressure, temperature and time period can vary in embodiments. Examples of suitable gases are inert gases and reducing gases.

Method 800 includes forging 808 the bonded layers of emitting material, primary substrate material, and secondary substrate material to desired dimensions of the target cap. Method 800 includes machining 810 the bonded layers of emitting material, primary substrate material, and secondary substrate material to impart work into the primary substrate material, secondary substrate material, and emitting material. According to an embodiment, work is imparted into at least one of the primary substrate material, secondary substrate material, and emitting material. According to an embodiment, at least about 99.0% of work is imparted into the primary substrate material, secondary substrate material, and emitting material. According to an embodiment, at least about 99.0% of work is imparted into at least one of the primary substrate material, secondary substrate material, and emitting material.

In an embodiment, Method 800 provides a target cap including secondary substrate material formed of lower bond strength substrate material suitable to resist growth of cracking in the axial direction, as previously described herein. In an embodiment, lower bond strength substrate material is formed of a preformed wrought sheet of suitable dense secondary substrate material as previously described herein and having bond strength lower than primary substrate material and suitable to resist cracking in the axial direction. In an embodiment, the lower bond strength material is initially formed on the primary substrate rear transition by depositing the lower bond strength material by powder coating, plasma spraying, electroplating, chemical vapor deposition, or physical vapor deposition, and the lower bond strength material and primary substrate material are further joined by diffusion bonding of the lower bond strength material and primary substrate material in the secondary bonded interface.

In an embodiment, at least one of primary substrate material layer and secondary substrate material layer has predetermined mechanical strength properties, as elsewhere described herein. In an embodiment, at least one of primary substrate material layer and secondary substrate material layer has low bond strength and is suitable to resist growth of cracking in the axial direction. In an embodiment, the primary substrate material layer has predetermined mechanical strength properties and the secondary substrate material layer has low bond strength and is suitable to resist growth of cracking. In an embodiment, the secondary substrate material layer has predetermined mechanical strength properties and the primary substrate material layer has low bond strength and is suitable to resist cracking in the axial direction.

### CONCLUSION

X-ray targets, X-ray apparatus, and X-ray imaging systems according to embodiments of the disclosure are described. Although specific embodiments are illustrated and described herein, it will be appreciated by those of ordinary skill in the art that any arrangement which is calculated to achieve the same purpose can be substituted for the specific embodiments shown. This application is intended to cover any adaptations or variations of the embodiments and disclosure. For example, although described in terminology and terms common to the field of X-ray imaging systems, X-ray apparatus and X-ray targets, one of ordinary skill in the art will appreciate that implementations can be made for other systems, apparatus or methods that provide the required function.

In particular, one of ordinary skill in the art will readily appreciate that the names of the methods and apparatus are not intended to limit embodiments or the disclosure. Furthermore, additional methods, steps, and apparatus can be added to the components, functions can be rearranged among the components, and new components to correspond to future enhancements and physical devices used in embodiments can be introduced without departing from the scope of embodiments and the disclosure. One of skill in the art will readily recognize that embodiments are applicable to future X-ray imaging systems, X-ray apparatus, anode assemblies, X-ray targets, target caps, different substrate materials, and different emitting materials.

Terminology used in the present disclosure is intended to include all environments and alternate technologies which provide the same functionality described herein.

We claim:

1. An X-ray target produced by the method of:
stacking a primary substrate layer and a focal track layer, the primary substrate layer being formed of primary substrate material defining a primary front surface, the focal track layer being formed of emitting material defining a focal track rear surface, a primary front transition of the primary front surface being in abutting relationship with a focal track rear transition of the focal track rear surface;
compacting the emitting material and the primary substrate material together at elevated pressure to bring the primary front transition and the focal track rear transition into intimate abutting relationship, cooperation of the primary front transition and the focal track rear transition defining a primary compacted interface between the primary substrate material and the emitting material; and
bonding the emitting material to the primary substrate material in the primary compacted interface by heating the primary compacted interface to an elevated temperature while maintaining the elevated pressure for a time period to form a primary bonded interface of the emitting material and the primary substrate material, the emitting material and the primary substrate material being integrally bonded by one of diffusion bonding, diffusion brazing, and brazing.

2. The X-ray target of claim 1 and further comprising:
stacking a secondary substrate layer adjacent the primary substrate layer, the secondary substrate layer being formed of secondary substrate material defining a secondary front surface, the primary substrate layer having a primary rear surface in spaced relation to the primary front surface, the secondary front surface being in abutting relationship with the primary rear surface;
compacting the secondary substrate material and the primary substrate material together at elevated pressure to bring the secondary front surface and the primary rear surface into intimate abutting relationship, cooperation of the abutting secondary front surface and primary rear surface defining a secondary compacted interface between the secondary substrate material and the primary substrate material; and
bonding the secondary substrate material to the primary substrate material in the secondary compacted interface by heating the secondary compacted interface to an elevated temperature while maintaining the elevated pressure for a time period to form a secondary bonded interface of the secondary substrate material and the primary substrate material, the secondary substrate material and the primary substrate material being integrally bonded by one of diffusion bonding, diffusion brazing, and brazing.

3. The X-ray target of claim 2 and further comprising:
at least one of the emitting material and the primary substrate material in the primary bonded interface and the primary substrate material and the secondary substrate material in the secondary bonded interface having therein a lower bond strength material suitable to resist growth of cracking.

4. The X-ray target of claim 2 and further comprising:
at least one of the focal track layer being formed of a preformed wrought sheet of dense emitting material, the primary substrate layer being formed of a preformed wrought sheet of dense primary substrate material, and the secondary substrate layer being formed of a preformed wrought sheet of dense secondary substrate material.

5. The X-ray target of claim 1 and further comprising:
a portion of the primary substrate material having refined microstructure formed by imparting therein at least about 90.0% of mechanical work.

6. The X-ray target of claim 1 and further comprising:
the primary substrate material having a minimum density greater than or equal to about 95.0% of theoretical density.

7. The X-ray target of claim 6 and further comprising:
the primary substrate material having a minimum density greater than or equal to about 96.0% of theoretical density.

8. The X-ray target of claim 7, and further comprising:
the primary substrate material having a minimum density greater than or equal to about 97.0% of theoretical density.

9. The X-ray target of claim 8, and further comprising:
the primary substrate material having a minimum density greater than or equal to about 98.0% of theoretical density.

10. The X-ray target of claim 9, and further comprising:
the primary substrate material having a minimum density greater than or equal to about 99.0% of theoretical density.

11. The X-ray target of claim 2 and further comprising:
the primary substrate material being selected from the group of molybdenum, alloys of molybdenum, tungsten, and alloys of tungsten, the secondary substrate material being selected from the group of molybdenum, alloys of molybdenum, tungsten, and alloys of tungsten, and the emitting material being selected from the group of tungsten and alloys of tungsten.

12. An X-ray target manufactured by the method of:
stacking a focal track layer of emitting material and a primary substrate layer of primary substrate material, the primary substrate layer having a primary front surface, the primary front surface having a primary front transition, at least one of the emitting material and the primary substrate material having refined microstructure formed by imparting into the primary substrate material mechanical work sufficient to form the refined microstructure; and
bonding the emitting material to the primary substrate material in the primary front transition in a primary bonded interface, the emitting material and the substrate material in the primary bonded interface being bonded by one of diffusion bonding, diffusion brazing and brazing.

13. The X-ray target of claim 12 and further comprising:
bonding the emitting material to the primary substrate material in the primary bonded interface by heating the emitting material and the primary substrate material to an elevated temperature while maintaining elevated pressure by application of gas pressure for a time period sufficient to form between the emitting material and the primary substrate material one of diffusion bonding, diffusion brazing and brazing.

14. The X-ray target of claim 12 and further comprising:
the focal track layer having a focal track rear transition, the focal track rear transition being in abutting relationship with the primary front transition in a primary bonded interface, the emitting material and primary substrate material in the primary bonded interface being intimately bonded together by one of diffusion bonding, diffusion brazing, and brazing.

15. The X-ray target of claim 12 and further comprising:
at least one of the focal track layer being formed of a preformed wrought sheet of dense emitting material and the primary substrate layer being formed of a preformed wrought sheet of dense primary substrate material.

16. The X-ray target of claim 12 and further comprising:
at least one of the emitting material and the primary substrate material in the primary bonded interface having therein a lower bond strength material suitable to resist growth of cracking.

17. The X-ray target of claim 12 and further comprising:
at least one of the focal track layer being formed of a preformed wrought sheet of dense emitting material and the primary substrate layer being formed of a preformed wrought sheet of dense primary substrate material, the at least one of the focal track layer formed of a preformed wrought sheet of dense emitting material and the primary substrate layer formed of a preformed wrought sheet of dense primary substrate material having refined microstructure formed by imparting therein at least about 90.0% of mechanical work.

18. The X-ray target of claim 12 and further comprising:
the primary substrate material being selected from the group of molybdenum, alloys of molybdenum, tungsten, and alloys of tungsten, and the emitting material being selected from the group of tungsten and alloys of tungsten.

19. The X-ray target of claim 18 and further comprising:
stacking a secondary substrate layer adjacent the primary substrate layer, the secondary substrate layer being formed of secondary substrate material defining a secondary front surface, the primary substrate layer having a primary rear surface in spaced relation to the primary front surface, the secondary front surface being in abutting relationship with the primary rear surface, the secondary substrate material being selected from the group of molybdenum, alloys of molybdenum, tungsten, and alloys of tungsten; and
bonding to the primary rear transition at least a portion of the secondary front surface, the secondary substrate material and the primary substrate material being integrally bonded by one of diffusion bonding, diffusion brazing, and brazing.

20. An X-ray target manufactured by the method of:
stacking a focal track layer of emitting material and a primary substrate layer of primary substrate material, the emitting material being selected from the group of tungsten and alloys of tungsten, the primary substrate material being selected from the group of molybdenum, alloys of molybdenum, tungsten, and alloys of tungsten, the focal track layer having a focal track rear transition, the primary substrate layer having a primary front surface, the primary front surface having a primary front transition, the focal track rear transition being in abutting relationship with the primary front transition in a primary bonded interface, at least one of the focal track layer being formed of a preformed wrought sheet of dense emitting material and the primary substrate layer being formed of a preformed wrought sheet of dense primary substrate material, at least one of the emitting material and the primary substrate material having refined microstructure formed by imparting therein at least about 90.0% of mechanical work to form the refined microstructure;
stacking a secondary substrate layer adjacent the primary substrate layer, the secondary substrate layer being formed of secondary substrate material defining a secondary front surface, the primary substrate layer having a primary rear surface in spaced relation to the primary front surface, the secondary front surface being in abutting relationship with the primary rear surface, the secondary substrate material being selected from the group of molybdenum, alloys of molybdenum, tungsten, and alloys of tungsten; and
bonding the emitting material to the primary substrate material in the primary front transition in a primary bonded interface, bonding the secondary substrate material to the primary substrate material in a secondary bonded interface formed by at least a portion of the secondary front surface and at least a portion of the primary rear surface, by heating the emitting material, the primary substrate material and the secondary substrate material to a homologous temperature between about 0.3 of the lowest melting component thereof and about 0.8 of the highest melting component thereof, while maintaining elevated pressure between about 35 MPa and about 500 MPa by application of gas pressure for a time period between at least about 1 minute and about 100 hours, to form in a primary bonded interface one of diffusion bonding, diffusion brazing and brazing between the emitting material and the primary substrate material, and to form in a secondary bonded interface one of diffusion bonding, diffusion brazing and brazing between the primary substrate material and the secondary substrate material.
